(19) United States
(12) Patent Application Publication
(10) Pub. No.: US 2025/0234022 A1
(43) Pub. Date: Jul. 17, 2025

(54) NEURAL NETWORK-BASED CODING AND DECODING

(71) Applicant: Technology Innovation Institute - Sole Proprietorship LLC, Masdar City (AE)

(72) Inventor: Wassim HAMIDOUCHE, Abu Dhabi (AE)

(73) Assignee: Technology Innovation Institute - Sole Proprietorship LLC, Masdar City (AE)

(21) Appl. No.: 19/016,991

(22) Filed: Jan. 10, 2025

Related U.S. Application Data
(60) Provisional application No. 63/621,233, filed on Jan. 16, 2024.

(51) Int. Cl. H04N 19/42; H04N 19/124; H04N 19/13; H04N 19/136; H04N 19/184; H04N 19/31; H04N 19/33

(52) U.S. Cl. CPC H04N 19/42; H04N 19/124; H04N 19/13; H04N 19/136; H04N 19/184; H04N 19/31; H04N 19/33

(57) ABSTRACT

Disclosed herein are system, method, and computer program product embodiments for neural network-based coding and decoding of video data. An embodiment determines a temporal scaling factor based on a measure of temporal variability of the video data. The embodiment also determines a spatial scaling factor based on a measure of spatial variability of the video data. The embodiment then generates temporally and spatially down-scaled video data based on the temporal and spatial scaling factors. The embodiment then encodes the temporally and spatially down-scaled video data as a neural network having weight parameters. The embodiment then generates a bit stream of encoded video data based on the weight parameters.

### CROSS REFERENCES

This application claims the benefit of U.S. Provisional Application No. 63/621,233 filed Jan. 16, 2024, titled “NEURAL NETWORK-BASED CODING AND DECODING,” the content of which is herein incorporated by reference in its entirety.

### BACKGROUND

Multimedia applications, such as augmented reality (AR), virtual reality (VR), 4K/8K video streaming, and cloud gaming, require substantial bandwidth and storage resources to deliver immersive and high-quality experiences to users. Efficient video encoding and compression techniques are important to address bandwidth and storage constraints, especially when dealing with high-resolution and high-rate video content. These techniques enable the transmission and storage of high-resolution video data, while minimizing the required bandwidth and storage space.

### SUMMARY

Aspects of this disclosure relate to apparatuses and methods for neural network-based coding and decoding of video data. For example, aspects of this disclosure relate to performing adaptive spatio-temporal downscaling of video data and encoding the downscaled video data as parameters of a neural network.

Aspects of this disclosure relate to a video encoding system with a memory device and a processor device coupled to the memory device. In aspects, the processor device determines a temporal scaling factor based on a measure of temporal variability of the video data. The processor device also determines a spatial scaling factor based on a measure of spatial variability of the video data. The processor device generates temporally and spatially downscaled video data based on the temporal and spatial scaling factors. The temporally and spatially downscaled video data is then encoded as a neural network having weight parameters. A binary bit stream of encoded video data is generated based on the weight parameters.

Aspects of this disclosure relate to a video decoding system with a memory device and a processor device coupled to the memory device. In aspects, the processor device receives a temporal scaling factor, a spatial scaling factor, and weight parameters of downscaled video data. The processor device generates predicted video data corresponding to the downscaled video data using the weight parameters. Predicted video data corresponding to the downscaled video data is generated using the weight parameters.

This Summary is provided merely for purposes of illustrating aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

The accompanying drawings are incorporated herein and form a part of the specification.

FIG. 1 illustrates a block diagram of a system that implements neural network-based coding and decoding of video data, according to aspects of this disclosure.

FIG. 2A illustrates a block diagram of a neural network-based pre-processing device, according to aspects of this disclosure.

FIG. 2B illustrates a block diagram of a neural network-based post-processing device, according to aspects of this disclosure

FIG. 3 illustrates a block diagram of a neural network that encodes downscaled video data generated by a pre-processing device, according to aspects of this disclosure.

FIG. 4 illustrates a block diagram of a conditional generative adversarial network (GAN) that encodes downscaled video data, according to aspects of this disclosure.

FIG. 5 illustrates a process for compressing neural network parameters that encode downscaled video data, according to aspects of this disclosure.

FIG. 6 is a flowchart for a method for neural network-based encoding of video data, according to aspects of this disclosure.

FIG. 7 is a flowchart for a method for neural network-based decoding of video data, according to aspects of this disclosure.

FIG. 8 illustrates an example computer system useful for implementing various embodiments of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for neural network-based coding and decoding. For example, embodiments herein describe performing adaptive spatio-temporal downscaling of video data and encoding the downscaled video data as parameters of a neural network.

Increasing demand for high-resolution and high frame rate video applications presents several challenges related to data volume, network demands, storage, computational requirements, and maintaining quality. Efficient video coding and compression technologies are important to address these challenges and make the distribution and consumption of high-resolution content seamless. Video compression techniques reduce the size of video data while aiming to maintain an acceptable level of visual quality. These techniques exploit redundancies in video content to eliminate or represent data more efficiently, resulting in smaller file sizes that are easier to store, transmit, and process.

Video compression standards can include advanced video coding (AVC), high-efficiency video coding (HEVC), and versatile video coding (VCC). The AVC standard (or the H.264 standard) is used for applications, such as streaming, video conferencing, digital television, and Blu-ray discs. The HEVC standard (or the H.265 standard) is used for 4K and HDR content, as well as streaming on platforms with limited bandwidth. The VCC standard (or the H.266 standard) is an evolution of the H.265 standard. The VCC standard is designed to further improve compression efficiency and may support applications, such as 8K video and VR applications.

Neural network-based video encoding, also known as implicit neural representation, is an approach that leverages artificial neural networks to efficiently encode video data. Neural network-based encoding represents video data as a function approximated by a neural network, leading to improved encoding and decoding speeds over other compression techniques. Furthermore, neural network-based encoding benefits from hardware super-resolution and frame interpolation modules on televisions and mobile devices. However, the neural representation of a high-resolution and high frame rate video may require a large neural network with multiple layers and a large number (e.g., millions) of parameters. Hence, video data encoded onto neural network parameters may require large bandwidth and storage resources. Accordingly, what is needed are bandwidth and storage-efficient techniques for neural representation of video data.

To address the above technological challenges, embodiments herein perform a spatio-temporal downscaling of video data using a neural network-based pre-processing device before encoding the video data as a specialized neural network. The spatial and temporal scaling factors are determined adaptively based on measures of spatial and temporal variability of the video data. A neural network-based post-processing device and the pre-processing device are trained jointly to minimize distortion between the encoded and decoded video data.

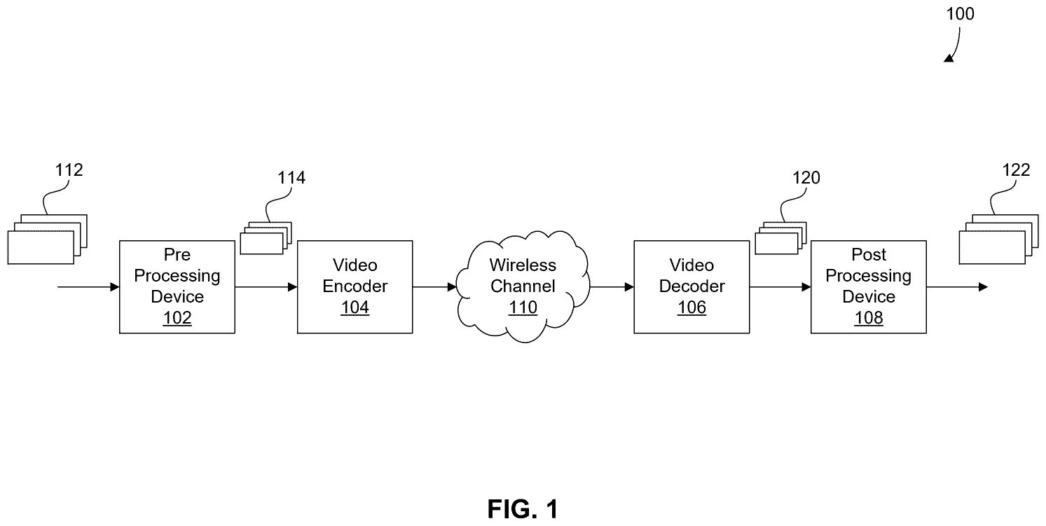

FIG. 1 illustrates a block diagram of system 100 that implements neural network-based coding and decoding of video data, according to aspects of this disclosure. In one example, system 100 may include a pre-processing device 102, a video encoder 104, a video decoder 106, and a post-processing device 108. In aspects, pre-processing device 102 may use a machine learning (ML) algorithm or a deep neural network to predict temporal and spatial scaling factors based on input video data 112. Based on the predicted temporal and spatial scaling factors, pre-processing device 102 may scale video data 112 to generate downscaled video data 114.

In aspects of this disclosure, video encoder 104 may process the downscaled video data 114 and encode the scaled video data 114 as parameters of a neural network (e.g., as weights of the trained neural network). The parameters of the neural network generated by video encoder 104 may be transmitted to video decoder 106 over a communication channel (e.g., a wired channel or a wireless channel 110). Alternatively, or in addition, the parameters of the neural network generated by video encoder 104 may be stored on a storage device (e.g., a local storage device or a cloud-based storage device), and video decoder 106 may retrieve the parameters of the neural network from the storage device.

In aspects, video decoder 106 may receive the parameters corresponding to the neural network that encodes scaled video data 114. Video decoder 106 may reconstruct the neural network using the received parameters. The reconstructed neural network takes frame index values as an input and outputs a predicted downscaled video 120.

In aspects, post-processing device 108 may be configured to receive predicted downscaled video data 120 and the spatial and temporal scaling factors as inputs. Based on the received scaling factors, post-processing device 108 may upscale the predicted downscaled video data 120 and use a neural network to generate post-processed output video 122. In aspects, the neural networks at the pre-processing device 102 and the post-processing device 108 are jointly trained to minimize a loss function. In aspects, pre-processing device 102, video encoder 104, video decoder 106, and/or post-processing device 108 may be implemented using a hardware super resolution device and/or a neural processing device on a user device (e.g., mobile phone, TV, and virtual reality/augmented reality device.).

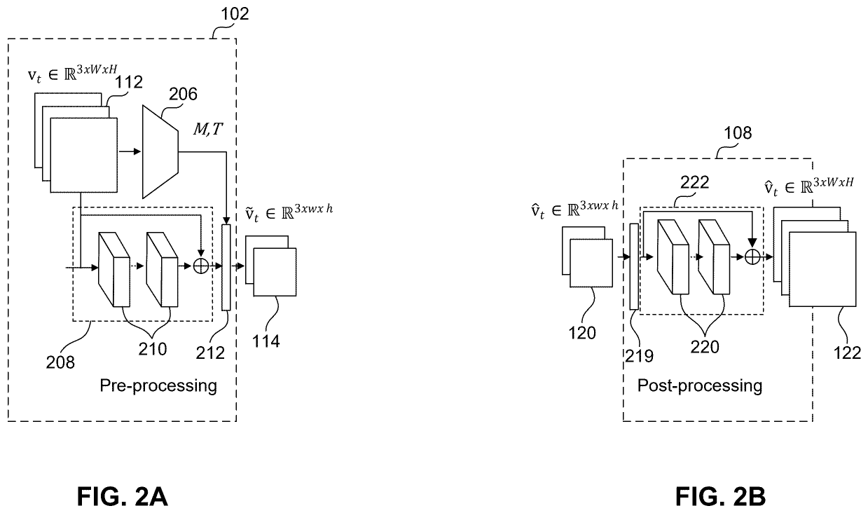

FIG. 2A illustrates a block diagram of a neural network-based pre-processing device 102, according to aspects of this disclosure. In aspects, pre-processing device 102 is configured to receive video data 112 as an input and generate processed and downscaled-video data 114. In aspects, pre-processing device 102 includes a scaling prediction device 206, a downscaling filter 212, and a pre-processing network 208 that includes convolution layers 210 and an identity mapping (e.g., a skip connection).

In aspects of this disclosure, scaling prediction device 206 is configured to process video data 112 and generate a spatial scaling factor (M) and a temporal scaling factor (T). Pre-processing network 208 processes input video data 112, and the output of pre-processing network 208 is provided as an input to downscaling filter 212. Based on the scaling factors M and T, downscaling filter 212 scales the output of pre-processing network 208 to generate downscaled video data 114.

In aspects, video data 112 including N video frames may be represented as V={νₜ}ₜ₌₁^{N}, where νₜ is a video frame at a time instance t. Each video frame νₜ may be composed of W×H RGB color-pixel values, where W and H are the width and height of video frame νₜ in pixels. Hence, video frame νₜ has dimensions of 3×W×H and νₜ∈R^{3×W×H}. Downscaling filter 212 generates downscaled video data 114 based on scaling factors M and T. Hence, when 0≤M, T≤1, downscaled video data 114 may include n=N*T video frames, and downscaled video frame \tilde{ν}ₜ has dimensions of 3×w×h, where w=W*M and h=H*M.

In aspects, scaling prediction device 206 may use an ML algorithm to predict the scaling factors M and T. Scaling factor prediction using an ML algorithm may be composed of two stages: feature extraction and regression to predict the scaling factors. In aspects, scaling prediction device 206 may extract temporal and spatial features corresponding to video data 112 and feed the extracted temporal and spatial features into an ML algorithm for regression to predict the scaling factors M and T.

In aspects, extracting temporal features from video data 112 involves capturing information that describes how objects and/or events change over time within video data 112. In aspects, temporal features may indicate measures of temporal variability of video data 112. In aspects, scaling prediction device 206 may use temporal feature extraction techniques, such as optical flow algorithms, trajectory analysis, and temporal histograms. In aspects, optical flow algorithms calculate the motion of objects between consecutive video frames (e.g., between νₜ and νₜ₊₁) by analyzing the change in intensity patterns of pixels. The motion vectors generated by optical flow algorithms capture the direction and speed of moving objects in video data 112. Trajectory analysis involves tracking objects or points of interest across multiple frames to extract trajectories. Temporal features, such as speed, acceleration, and curvature, can be derived from the trajectories. Temporal histograms create histograms of feature values (e.g., color, texture, and motion) over multiple video frames of video data 112. In aspects, a temporal feature indicating a measure of temporal variability (TV) of video data 112 may be represented as TV=median{std(Fₜ−Fₜ₋₁)}, where Fₜ and Fₜ₊₁ are the luminance components of video frame νₜ and νₜ₋₁, and the median and std are the median and standard deviation functions.

In aspects, extracting spatial features from video data 112 involves capturing information about static content within individual video frames (e.g., video frame νₜ) of video data 112. In aspects, spatial features may indicate measures of spatial variability of video data 112. In aspects, scaling prediction device 206 may use spatial feature extraction techniques, such as color histograms, texture analysis, and edge detection. Color histograms of color distribution within each frame may capture information about the dominant colors and their intensities. Texture analysis techniques, such as local binary patterns (LBP), may be used to characterize local patterns within each video frame. Edge detection algorithms, like Canny and Sobel, may be used to highlight object boundaries and contours within video frames. In aspects, a spatial feature indicating a measure of spatial variability (SV) of video data 112 may be represented as SV=median{std(Sobel(Fₜ))}, where Fₜ is the luminance components of video frame νₜ and Sobel is the Sobel operator to obtain gradient information of video frame νₜ.

In aspects, scaling prediction device 206 may input the extracted temporal and spatial features to an ML algorithm for regression to predict the scaling factors M and T. In aspects, to predict the scaling factors M and T, scaling prediction device 206 may use ML regression algorithms, such as decision tree regression, random forest regression, and support vector regression. Decision tree regression models scaling factors (e.g., the target variables) based on a tree-like structure of decisions. Leaf nodes of the decision tree may represent predicted values, and the tree may be trained to minimize prediction error. Random forest regression models are ensembles of decision trees, and they average or combine the predictions of multiple decision trees to reduce overfitting and improve accuracy.

In aspects, ML regression models used by scaling prediction device 206 may be trained to predict values of M and T that minimize distortion between input to pre-processing device 102 (e.g., video data 112) and output of post-processing device 108 (e.g., video data 114). In aspects, error metrics, such as mean squared error (MSE), root mean squared error (RMSE), mean absolute error (MAE), and R-squared error, L2 norm loss, may be used during the training of an ML regression models used by scaling prediction device 206.

In aspects, scaling prediction device 206 may use a deep neural network trained on an ImageNet dataset using a backbone network (e.g., a feature extractor), such as a visual geometry group (VGG) model and/or residual neural network (ResNet), for feature extraction. To predict the scaling factors M and T, the features from the dataset may be used to train an ML model, such as a transformer model, long short-term memory (LSTM) model, and reinforcement learning (RL) model. In aspects, scaling prediction device 206 may predict the scaling factors M and T based on temporal features that indicate measures of temporal variability (e.g., measure TV). Also, scaling prediction device 206 may predict the scaling factors M and T based on spatial features that indicate measures of spatial variability (e.g., measure SV).

In aspects, pre-processing network 208 processes input video data 112, and the output of pre-processing network 208 is provided as an input to downscaling filter 212. Pre-processing network 208 includes convolution layers 210 and an identity mapping (e.g., a skip connection). In aspects, convolution layers 210 may generate high frequency components corresponding to video data 112. Video data 112 may be added to the high frequency components generated by convolution layers 210, via the identity mapping, to generate the output of pre-processing network 208. Each convolution layer 210 of the pre-processing network 208 may have one or more 3D filters that slide or convolve over the input data, computing a dot product at each position. Each filter may include multiple kernels, which are small spatially constrained matrices (e.g., Sobel kernels). Each filter contains several weights (e.g., a 3×3×3 filter has 27 trainable weights) that may be trained to minimize a loss function. A convolution layer may pass the output of convolution through an activation function (e.g., rectified linear unit (ReLU)). The activation function may generate an output action map that becomes an input to the next convolution layer.

In aspects, the neural networks at pre-processing device 102 (e.g., scaling prediction device 206 and/or pre-processing network 208) and the neural networks at post-processing device 108 (e.g., post-processing network 222) may be jointly trained to improve the accuracy of the post-processed output video data 122. In aspects, an objective function (e.g., loss function) for training the weights of the neural networks at pre-processing device 102 and post-processing device 108 may include a component that corresponds to the amount of distortion between input video data 112 (e.g., νₜ) and the post-processed output video data 122 (e.g., ν̆ₜ). For example, the distortion between input video data 112 (e.g., νₜ) and the post-processed output video data 122 (e.g., ν̆ₜ) may be defined as Σₜ₌₁^{N}∥νₜ−ν̆ₜ∥₂² or Σₜ₌₁^{N}∥νₜ−ν̆ₜ∥₁. In aspects, the objective function may further include a structural similarity index measure (SSIM) metric. In aspects, a regularization component may be added to the loss function to prevent overfitting. Training of the neural networks at pre-processing device 102 and post-processing device 108 may be performed by optimizing the objective function using an optimization algorithm, such as a gradient descent algorithm, mini-batch gradient descent algorithm, root mean squared (RMS) prop, and Adam optimizer. The output of pre-processing network 208 is an input to downscaling filter 212.

In aspects, based on the scaling factors M and T, downscaling filter 212 scales the output of pre-processing network 208 to generate downscaled video data 114. In aspects, downscaling filter 212 may use a downscaling algorithm, such as bicubic interpolation, bilinear interpolation, and Lanczos resampling, to decrease the dimensions of video data 112. Downscaling filter 212 reduces the number of video frames (or video frame rate) by a factor of T and reduces the dimensions of each video frame νₜ by a factor of M.

FIG. 2B illustrates a block diagram of neural network-based post-processing device 108, according to aspects of this disclosure. In aspects, post-processing device 108 is configured to receive predicted downscaled video data 120 (e.g., video frames {\hat{ν}ₜ}ₜ₌₁ⁿ) and spatial and temporal scaling factors M and T as inputs. In aspects, post-processing device 108 includes an interpolation and upscaling filter 219 and a post-processing network 222 that includes convolution layers 220 and an identity mapping (e.g., a skip connection). In aspects, based on the received scaling factors M and T, interpolation and upscaling filter 219 can perform frame interpolation and spatial upscaling (e.g., super-resolution upscaling) of the predicted downscaled video data 120. Post-processing network 222 generates post-processed output video 122 by processing the video data generated by interpolation and upscaling filter 219.

In aspects of this disclosure, interpolation and upscaling filter 219 performs frame interpolation to increase the number of frames (or the video frame rate) by a factor of T. Next, based on the spatial scaling factor M, the interpolation and upscaling filter 219 performs spatial upscaling to enhance the number of pixels per frame to the original resolution (e.g., the resolution of video frame νₜ). Interpolation and upscaling filter 219 performs video interpolation by generating intermediate frames between existing frames to increase the frame rate of the predicted downscaled video data 120. In aspects, interpolation and upscaling filter 219 may use a video frame interpolation technique, such as optical flow based frame interpolation, phase-based frame interpolation, spline interpolation, and polynomial interpolation, to increase the number of frames of the predicted downscaled video data 120.

After performing frame interpolation, interpolation and upscaling filter 219 may perform spatial upscaling of video frames using an upscaling algorithm, such as bicubic interpolation, bilinear interpolation, and Lanczos resampling, to increase the dimensions of predicted downscaled video data 120. Spatial upscaling increases the dimensions of each video frame νₜ by a factor of M. For example, video frames {\hat{ν}ₜ}ₜ₌₁ⁿ received by interpolation and upscaling filter 219 may have dimensions of 3×w×h. Interpolation and upscaling filter 219 generates upscaled video data based on scaling factors M. Hence, when 0≤M, T≤1, the upscaled video data may include N=n/T video frames, and upscaled videos frame have dimensions of 3×W×H, where W=w/M and H=h/M.

In aspects, the configuration of post-processing network 222 may be similar to the configuration of pre-processing network 208. Post-processing network 222 includes convolution layers 220 and an identity mapping (e.g., a skip connection). Each convolution layer of the post-processing network 222 may have one or more filters. Each filter contains several weights that may be trained to minimize a loss function. In aspects, weights of the post-processing network 222 and the weights of the pre-processing network 208 may be trained jointly to minimize a loss function.

In aspects, the neural networks at pre-processing device 102 (e.g., scaling prediction device 206 and/or pre-processing network 208) and post-processing network 222 may be jointly trained to optimize an objective function (e.g., a loss function). In aspects, an objective function for training the neural networks at pre-processing device 102 and post-processing device 108 may include a component that corresponds to the amount of distortion between input video data 112 (e.g., νₜ) and the post-processed output video data 122 (e.g., \hat{ν}ₜ). For example, the distortion between input video data 112 (e.g., νₜ) and the post-processed output video data 122 (e.g., ν̆ₜ) may be defined as Σₜ₌₁^{N}∥νₜ−ν̆ₜ∥₂² or Σₜ₌₁^{N}∥νₜ−ν̆ₜ∥₁. Training of the neural networks at pre-processing device 102 and post-processing device 108 may be performed by optimizing the objective function using an optimization algorithm, such as gradient descent algorithm, mini-batch gradient descent algorithm, RMS prop, and Adam optimizer.

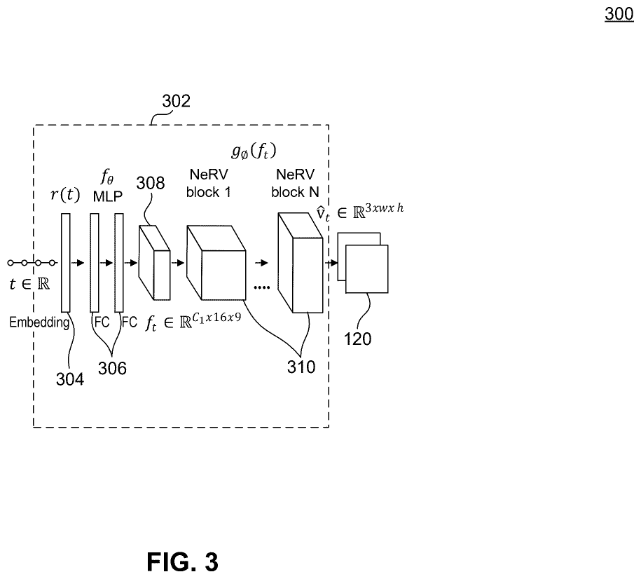

FIG. 3 illustrates a block diagram of a neural network 302 that encodes downscaled video data generated by pre-processing device 102, according to aspects of this disclosure. Referring to FIGS. 1 and 3, video encoder 104 may train neural network 302 to encode scaled video data 114 as the parameters and/or weights of neural network 302. Neural network 302 that is trained to encode downscaled video data 114 (e.g., video \tilde{V}{\tilde{ν}ₜ}ₜ₌₁ⁿ) may take a frame index t (or a time index t), normalized between 0 and 1, as an input and outputs the video frame \tilde{ν}ₜ corresponding to the frame index t. Video decoder 106 may receive the parameters and/or weights of trained neural network 302 and recreate neural network 302. Video decoder 106 may input frame indices t=1, . . . , n to the recreated neural network to generate predicted downscaled video frames {\hat{ν}ₜ}t=1, . . . , n.

Neural network 302 may include an embedding function 304 followed by a multi-layer perceptron (MLP) 306. MLP 306 may be followed by multiple convolutional blocks 308. Furthermore, each convolutional block may include a convolution layer, a sub-pixel convolution layer for upscaling, and an activation layer (e.g., ReLU).

In aspects, embedding function 304 may be a positional encoding function given by: Γ(t)=(sin(b⁰ πt), cos(b⁰πt), . . . , sin(b^{l-1}πt), cos(b^{l-1}−πt)), where t is the input frame index and b and 1 are hyper-parameters. The output of the embedding function is fed to the following MLP 306.

In aspects, MLP 306 may be denoted as function ƒ_{θ}, and the output of MLP 306 may be denoted as ƒₜ=RESHAPE (ƒ_{θ}(Γ(t))), where Γ(t) is the positional encoding function and RESHAPE is the function that reshapes a one dimensional feature vector to a 2D feature map ƒₜ∈R^{C×h×w}, where (h, w)=(9, 16), as an example.

In aspects, the group of convolution blocks 310 may be denoted as function g_{ϕ}, and the output of convolution blocks 310, given input ƒₜ, may be denoted as g_{ϕ}(ƒₜ).

In aspects, neural network 302 is trained to encode scaled video data 114 as parameters and/or weights of neural network 302. Hence, information corresponding to scaled video 114 may be embedded within the architecture and parameters of neural network 302. In aspects, video encoder 104 may determine/train the weights of neural network 302 (e.g., the weights of MLP 306 and convolution blocks 310) by minimizing a loss function that represents distortion between the output g_{ϕ}(ƒₜ) of neural network 302 and the corresponding down sampled video frame \hat{ν}ₜ, which is the ground truth.

In aspects, video encoder 104 may determine/train the weights of neural network 302 by minimizing the following loss function:

$$L = \frac{1}{n} {\sum }_{t = 1}^{n} α {‖ {g}_{ϕ} ( {f}_{t} ) - {\hat{v}}_{t} ‖}_{1} + ( 1 - α ) ( 1 - SSIM ( {g}_{ϕ} ( {f}_{t} , {\hat{v}}_{t} ) ) ,$$

where SSIM is the structural similarity index measure.

In aspects, training the weights of neural network 302 may be performed by optimizing the loss function L using an optimization algorithm, such as a gradient descent algorithm, mini-batch gradient descent algorithm, RMS prop, and Adam optimizer.

In aspects, the trained weights of neural network 302 that encode scaled video data 114 (e.g., video \tilde{V}={\tilde{ν}ₜ}ₜ₌₁ⁿ) may be transmitted to video decoder 106 via a communication channel (e.g., a wired channel or a wireless channel 110). Alternatively, or in addition, the trained weights of neural network 302 may be stored on a storage device (e.g., a local storage device or a cloud-based storage device), and video decoder 106 may retrieve the weights and/or parameters corresponding to neural network 302 from the storage device.

In aspects, video decoder 106 may recreate neural network 302 from the trained weights and parameters generated by video encoder 104. Video decoder 106 may generate predicted downscaled video frames {\hat{ν}ₜ}ₜ₌₁ⁿ by inputting frame indices t=1, . . . , n to the recreated neural network. Video decoder 106 inputs predicted downscaled video frames 120 (e.g., {\hat{ν}ₜ}ₜ₌₁ⁿ) to post-processing device 108 to upscale and generate post-processed output video data 122.

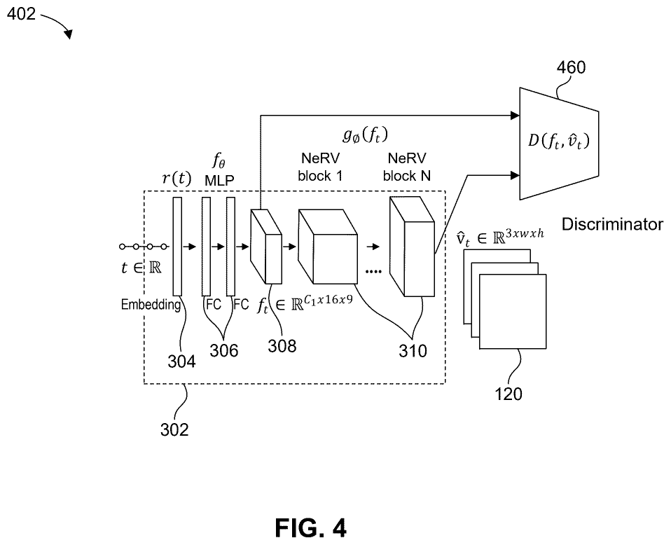

FIG. 4 is a block diagram illustrating a conditional generative adversarial network (GAN) 402 that encodes downscaled video data 114 generated by pre-processing device 102, In aspects of this disclosure. Conditional GAN 402 is trained to encode scaled video data 114 as parameters and/or weights of conditional GAN 402. In conditional GAN 402, neural network 302 may act as a generator neural network, and discriminator 404 is a discriminator neural network.

In aspects, video encoder 104 may determine/train the weights of conditional GAN 402 by minimizing the following loss functions:

$${L}_{G} = \frac{1}{n} {\sum }_{t = 1}^{n} α {‖ {g}_{ϕ} ( {f}_{t} ) - {\hat{v}}_{t} ‖}_{1} + β ( 1 - SSIM ( {g}_{ϕ} ( {f}_{t} ) , {\hat{v}}_{t} ) ) - γ log ( D ( {f}_{t} , {\hat{v}}_{t} ) ) , and$$

$${L}_{D} = \frac{1}{n} {\sum }_{t = 1}^{n} - log ( 1 - D ( {f}_{t} , {\hat{v}}_{t} ) ) - log ( D ( {f}_{t} , {v}_{t} ) ) ,$$

L_{G} is the loss function for the generator neural network and L_{D} is the loss function for the discriminator neural network of conditional GAN 402. SSIM is the structural similarity index measure. The term D(ƒₜ, \hat{ν}ₜ) is the Kullback-Leibler divergence or the relative entropy between ƒₜ and \hat{ν}ₜ. In aspects, using conditional GAN 402 may generate trained weights that provide improved perceptual quality at video decoder 106.

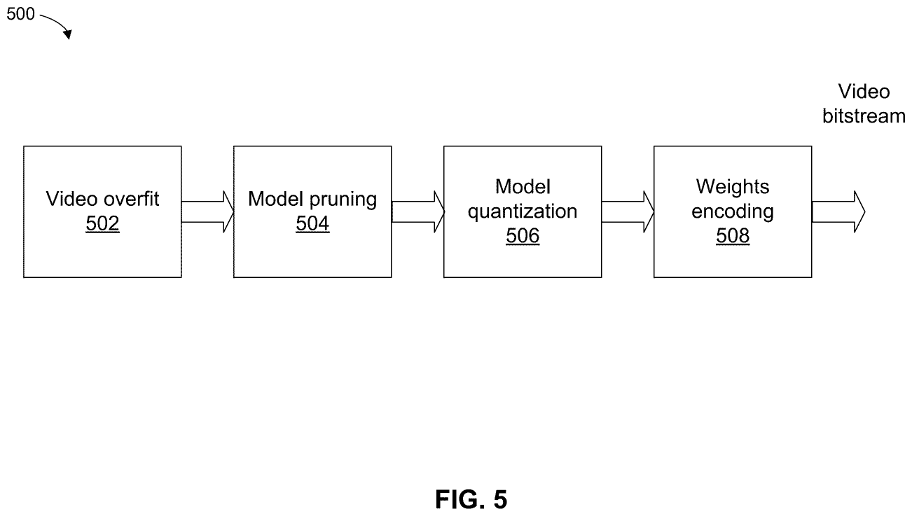

FIG. 5 illustrates a method 500 for compressing neural network parameters (e.g., weights of neural network 302) that encode downscaled video data 114, according to aspects of this disclosure. The trained weights of neural network 302 that encode scaled video data 114 (e.g., video \tilde{V}={\tilde{ν}ₜ}ₜ₌₁ⁿ) may be transmitted to video decoder 106 via a communication channel (e.g., a wired channel or a wireless channel 110). The trained weights of neural network 302 may be compressed for efficient transmission over the communication channel. Video encoder 104 may perform model pruning, model quantization, and/or entropy encoding to compress the trained weights of neural network 302 (e.g., to reduce the size of the set of trained weights of neural network 302) before transmitting them to video decoder 106.

At 502, video encoder 104 performs video overfitting by fitting neural network 302 to downscaled video data 114. Accordingly, the trained weights corresponding to neural network 302 embed all information corresponding to downscaled video data 114. Furthermore, since neural network 302 includes multiple convolution and fully-connected layers, the parameter set (e.g., the set of trained weights) encoding the video data may be very large. In aspects of this disclosure, the parameter set corresponding to neural network 302 may be compressed using various techniques, such as model pruning, model quantization, and weight encoding.

At 504, a model pruning technique may be used to identify redundancies in the parameter set corresponding to the neural network. The parameter set may then be reduced in size by removing redundant and/or noncritical parameters. Example model pruning techniques include global pruning, weight pruning, and neuron pruning.

At 506, a model quantization is performed on the pruned parameter set. Model quantization compresses the parameter set by reducing the number of bits required to represent each weight. However, quantization may lead to a loss of accuracy due to the reduced representation precision. The degree of accuracy loss depends on the structure of neural network 302 and the level of quantization applied.

At 508, weights encoding is performed by further compressing the quantized parameter set using entropy encoding. In aspects, entropy encoding performs parameter compression by efficiently representing parameters by assigning shorter codes to frequently occurring parameters and longer codes to less frequent parameters of the parameter set. Entropy encoding achieves compression by taking advantage of varying probabilities of the model parameters in a parameter set and reduces the length of the coded data. Example entropy encoding techniques include Huffman coding and arithmetic coding.

In aspects, the average number of bits needed to encode the set of weights corresponding to MLP 306 of neural network 302 may equal the entropy of the set of weights of MLP 306. The entropy of the set of weights of MLP 306 may be determined as Σ_{θ∈θ}I(θ)=−Σ_{θ∈θ}p(θ)log₂p(θ), where Θ is the set of weights of MLP 306 and p(θ) is the probability/relative frequency corresponding to a weight θ∈Θ. Similarly, the average number of bits needed to encode the set of weights corresponding to convolution blocks 308 of neural network 302 may equal the entropy of the set of weights of convolution blocks 308. The entropy of the set of weights of convolution blocks 308 may be determined as Σ_{ϕ∈Φ}I(ϕ)=−Σ_{ϕ∈Φ}p(ϕ)log₂p(ϕ), where ϕ is the set of weights of convolution blocks 308 and p(ϕ) is the probability/relative frequency corresponding to a weight ϕ∈Φ.

In aspects, to generate trained weights that are more compressible (e.g., needs fewer number of bits to encode) with entropy encoding, the loss function for training the weights of neural network 306 may be modified to include an entropy penalization term. The modified loss function is

$$L = \frac{1}{n} {\sum }_{t = 1}^{n} α {‖ {g}_{ϕ} ( {f}_{t} ) - {\hat{v}}_{t} ‖}_{1} + ( 1 - α ) ( 1 - SSIM ( {g}_{ϕ} ( {f}_{t} ) , {\hat{v}}_{t} ) ) + γ ( {\sum }_{θϵΘ} I ( θ ) + {\sum }_{ϕϵΦ} I ( ϕ ) ) , where γ ( {\sum }_{θϵΘ} I ( θ ) + {\sum }_{ϕϵΦ} I ( ϕ ) )$$

is the entropy penalization term, and Σ_{θ∈Θ}(θ) indicates the entropy of the set of weights of MLP 306 and Σ_{ϕ∈Φ}I(ϕ) indicates the entropy of the set of weights of convolution blocks 308. Using the modified function to train the weights of neural network 302 may generate trained weights with reduced entropy. Hence, the trained weights may have improved compressibility using entropy coding.

In aspects, the video bitstream output by the entropy encoder may be further modulated by a radio frequency front-end device before transmitting over a communication channel (e.g., wired channel or a wireless channel 110). A receiver device with video decoder 106 may receive the video bit stream and decode the neural network parameters. Alternatively, or in addition, the output video bitstream may be stored on a storage device (e.g., a local storage device or a cloud-based storage device), and video decoder 106 may retrieve the parameters of the neural network from the storage device.

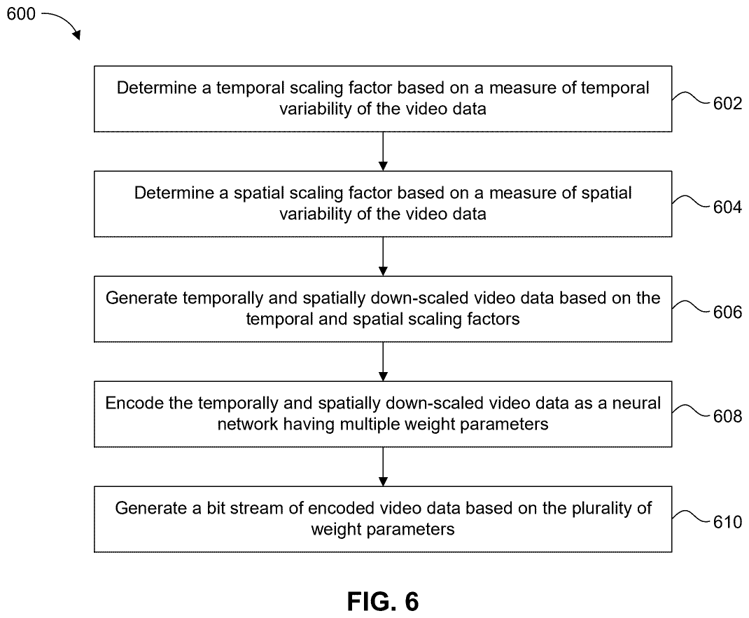

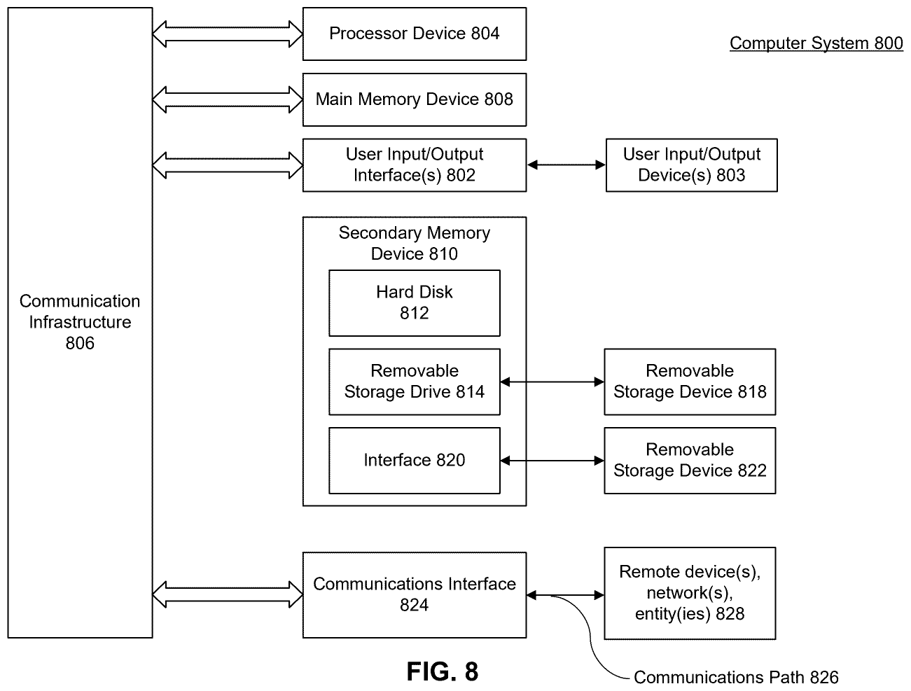

FIG. 6 illustrates a flowchart depicting a method 600 for neural network-based encoding of video data, according to aspects of this disclosure. Method 600 can be performed by processing logic that can include hardware (e.g., circuitry, dedicated logic, programmable logic, microcode, etc.), software (e.g., instructions executing on a processing device), or a combination thereof. As a convenience and not a limitation, FIG. 6 may be described with regard to elements of FIGS. 1, 2A, and 3. For example, the operations of FIG. 6 can be performed by pre-processing device 102 and video encoder 104. Method 600 can also be performed by computer system 800 of FIG. 8—described below. Method 600 is not limited to the specific aspects depicted in those figures, and other systems may be used to perform the method as will be understood by those skilled in the art. It is to be appreciated that not all operations may be needed, and the operations may not be performed in the same order as shown in FIG. 6.

At 602, neural network-based pre-processing device 102 determines a temporal scaling factor based on a measure of temporal variability of the video data. In aspects, scaling prediction device 206 of pre-processing device 102 may use an ML algorithm to predict a temporal scaling factor T. Scaling factor prediction using an ML algorithm may be composed of two stages: feature extraction and regression to predict the scaling factors. In aspects, scaling prediction device 206 may extract temporal features corresponding to video data 112 and feed the extracted temporal features into an ML algorithm for regression to predict the temporal scaling factor T.

In aspects, scaling prediction device 206 may use temporal feature extraction techniques, such as optical flow algorithms, trajectory analysis, and temporal histograms. Temporal features extracted by scaling prediction device 206 may include frame rate, motion vectors, temporal difference, and LSTM features. In aspects, a temporal feature indicating a measure of temporal variability of video data 112 may be represented as TV=median{std(Fₜ−Fₜ₋₁)}, where Fₜ and Fₜ₋₁ are the luminance components of video frame νₜ and νₜ₋₁, and the median and std are the median and standard deviation functions. In aspects, the temporal scaling factor may be a value between zero and one and is proportional to the measure of temporal variability.

In aspects, scaling prediction device 206 may input the extracted temporal features to an ML algorithm for regression to predict the temporal scaling factor T. In aspects, ML regression models used by scaling prediction device 206 may be trained to predict a value of T that minimizes distortion between input to pre-processing device 102 (e.g., video data 112) and output of post-processing device 108 (e.g., video data 114).

At 604, neural network-based pre-processing device 102 determines a spatial scaling factor based on a measure of spatial variability of the video data. In aspects, scaling prediction device 206 of pre-processing device 102 may use an ML algorithm to predict the spatial scaling factors M. Scaling factor prediction using an ML algorithm may be composed of two stages: feature extraction and regression to predict the scaling factors. In aspects, scaling prediction device 206 may extract spatial features corresponding to video data 112 and feed the extracted temporal and spatial features into an ML algorithm for regression to predict the spatial scaling factors M.

In aspects, scaling prediction device 206 may use spatial feature extraction techniques such as color histograms, texture analysis, and edge detection. Spatial features extracted by scaling prediction device 206 may include color histograms, texture features, local binary patterns, histograms of oriented gradients, and contour features. In aspects, a spatial feature indicating a measure of spatial variability of video data 112 may be represented as SV=median{std(Sobel(Fₜ))}, where Fₜ is the luminance components of video frame νₜ and Sobel is the Sobel operator to obtain gradient information of video frame νₜ. In aspects, the spatial scaling factor may be a value between zero and one and is proportional to the measure of spatial variability.

In aspects, scaling prediction device 206 may input the extracted spatial features to an ML algorithm for regression to predict the spatial scaling factor M. In aspects, ML regression models used by scaling prediction device 206 may be trained to predict a value of M that minimizes distortion between the input to pre-processing device 102 (e.g., video data 112) and output of post-processing device 108 (e.g., video data 114).

At 606, pre-processing device 102 generates temporally and spatially downscaled video data based on the temporal and spatial scaling factors. In aspects, pre-processing network 208 of pre-processing device 102 may process input video data 112, and the output of pre-processing network 208 is provided as an input to downscaling filter 212. In aspects, the neural networks at pre-processing device 102 (e.g., scaling prediction device 206 and/or pre-processing network 208) and the neural networks at post-processing device 108 (e.g., post-processing network 222) may be jointly trained to minimize a loss function. In aspects, a loss function for training the weights of the neural networks at pre-processing device 102 and post-processing device 108 may include a component that corresponds to the amount of distortion between input video data 112 (e.g., νₜ) and post-processed output video data 122 (e.g., Pt). For example, the distortion between input video data 112 (e.g., νₜ) and the post-processed output video data 122 (e.g., ν̆ₜ) may be defined as Σₜ₌₁^{N}∥νₜ−ν̆ₜ∥₂² or Σₜ₌₁^{N}∥νₜ−ν̆ₜ∥₁.

In aspects, the trained weights corresponding to the neural networks at pre-processing device 102 (e.g., scaling prediction device 206 and/or pre-processing network 208) are not transmitted to video decoder 106. Accordingly, the trained weights corresponding to the neural networks at pre-processing device 102 and the weights corresponding to the neural networks at pre-processing device 102 may be shared by all encoder and decoder deployment instances. Alternatively, a subset of the trained weights (e.g., weights corresponding to one or more layers) corresponding to the neural networks at pre-processing device 102 (e.g., scaling prediction device 206 and/or pre-processing network 208) may be transmitted to video decoder 106. Alternatively, trained weights corresponding to the neural networks at pre-processing device 102 may be updated for each video data 112 and transmitted to video decoder 106.

In aspects, downscaling filter 212 scales the output of pre-processing network 208 to generate downscaled video data 114 using the predicted temporal and spatial scaling factors. In aspects, downscaling filter 212 may use a spatial downscaling algorithm, such as bicubic interpolation, bilinear interpolation, and Lanczos resampling, to decrease the dimensions of video data 112 (e.g., to decrease the number of pixels per frame). Downscaling filter 212 reduces the dimensions of each video frame νₜ by a factor of M. Downscaling filter 212 may then perform temporal scaling of the video data to reduce the number of video frames (or video frame rate) by a factor of T.

At 608, video encoder 104 encodes the temporally and spatially downscaled video data as a neural network having multiple weight parameters. Video encoder 104 may train neural network 302 to encode scaled video data 114 as the parameters and/or weights of neural network 302. Neural network 302 trained to encode downscaled video data 114 (e.g., video \tilde{V}={\tilde{ν}ₜ}ₜ₌₁ⁿ) may take a frame index t (or a time index t), normalized between 0 and 1, as an input and outputs the video frame \tilde{ν}ₜ corresponding to the frame index t.

In aspects, video encoder 104 may determine/train the weights of neural network 306 by minimizing the following loss function:

$$L = \frac{1}{n} {\sum }_{t = 1}^{n} α {‖ {g}_{ϕ} ( {f}_{t} ) - {\hat{v}}_{t} ‖}_{1} + ( 1 - α ) ( 1 - SSIM ( {g}_{ϕ} ( {f}_{t} ) , {\hat{v}}_{t} ) ) ,$$

where SSIM is the structural similarity index measure. Training the weights of neural network 302 may be performed by optimizing the loss function L using an optimization algorithm, such as a gradient descent algorithm, mini-batch gradient descent algorithm, RMS prop, and Adam optimizer.

At 610, video encoder 104 generates a bit stream of encoded video data based on the weight parameters. In aspects, the trained weights of neural network 302 that encode scaled video data 114 (e.g., video \tilde{V}={\tilde{ν}ₜ}ₜ₌₁^{N}) may be transmitted to video decoder 106 via a communication channel (e.g., a wired channel or a wireless channel 110). Furthermore, the trained weights corresponding to the neural networks at pre-processing device 102 (e.g., scaling prediction device 206 and/or pre-processing network 208) are not transmitted to video decoder 106 resulting in a higher coding efficiency. Alternatively, a subset of the trained weights (e.g., weights corresponding to one or more layers) corresponding to the neural networks at pre-processing device 102 (e.g., scaling prediction device 206 and/or pre-processing network 208) may be transmitted to video decoder 106. Alternatively, trained weights corresponding to the neural networks at pre-processing device 102 may be updated for each video data 112 and transmitted to video decoder 106. In aspects, before transmission, the parameter set corresponding to the neural network may be compressed and digitized using various techniques, such as model pruning, model quantization, and weight encoding (e.g., entropy encoding). The generated bit stream may be modulated onto a carrier signal for transmission to video decoder 106.

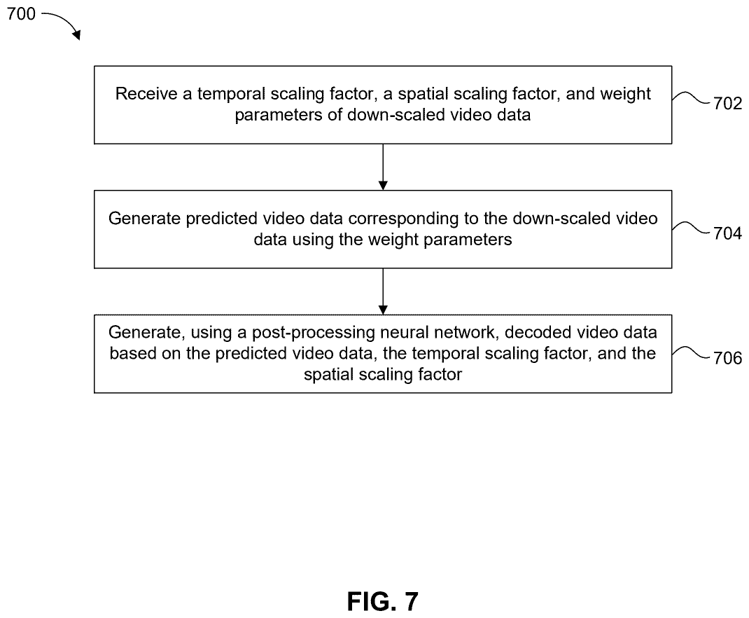

FIG. 7 illustrates a flowchart depicting a method 700 for neural network-based decoding of video data. Method 700 can be performed by processing logic that can include hardware (e.g., circuitry, dedicated logic, programmable logic, microcode, etc.), software (e.g., instructions executing on a processing device), or a combination thereof. As a convenience and not a limitation, FIG. 7 may be described with regard to elements of FIGS. 1, 2B, and 3. For example, the operations of FIG. 7 can be performed by post-processing device 108 and video decoder 106. Method 700 can also be performed by computer system 800 of FIG. 8. However, method 700 is not limited to the specific aspects depicted in those figures, and other systems may be used to perform the method as will be understood by those skilled in the art. It is to be appreciated that not all operations may be needed, and the operations may not be performed in the same order as shown in FIG. 7.

At 702, video decoder 106 receives a temporal scaling factor, a spatial scaling factor, and weight parameters of downscaled video data. In aspects, the temporal scaling factor and the spatial scaling factor are determined by pre-processing device 102 based on measures of temporal variability and spatial variability of video data 112. Video decoder 106 may receive spatial and temporal scaling factors M and T and the trained weights of neural network 302 from video encoder 104 over communication channel 110.

At 704, video decoder 106 generates downscaled predicted downscaled video data 120 corresponding to downscaled video data 114 using the received weight parameters. In aspects, video decoder 106 may recreate neural network 302 from the trained weights and parameters generated by video encoder 104. Video decoder 106 may generate predicted downscaled video frames {\hat{ν}ₜ}ₜ₌₁ⁿ by inputting frame indices t=1, . . . , n to the recreated neural network.

At 706, neural network-based post-processing device 108 generates post-processed output video data 122 (e.g., decoded video data) based on the predicted video data, the temporal scaling factor, and the spatial scaling factor. Post-processing device 108 may be configured to receive predicted downscaled video data 120 (e.g., video frames {\hat{ν}ₜ}ₜ₌₁ⁿ) and spatial and temporal scaling factors M and T as inputs.

In aspects, post-processing device 108 includes an interpolation and upscaling filter 219 and a post-processing network 222 that includes convolution layers 220 and an identity mapping (e.g., a skip connection). In aspects, based on the received scaling factors M and T, interpolation and upscaling filter 219 performs frame interpolation and spatial upscaling of the predicted downscaled video data 120. In aspects, interpolation and upscaling filter 219 first performs video interpolation (e.g., temporal upscaling) by generating intermediate frames between existing frames to increase the frame rate of the predicted downscaled video data 120. Interpolation and upscaling filter 219 may use a video frame interpolation technique, such as optical flow based frame interpolation, phase-based frame interpolation, spline interpolation, and polynomial interpolation, to increase the number of frames of the predicted downscaled video data 120. In aspects, interpolation and upscaling filter 219 may then perform spatial upscaling of video frames using an upscaling algorithm, such as bicubic interpolation, bilinear interpolation, and Lanczos resampling, to increase the spatial dimensions of predicted downscaled video data 120. Interpolation and upscaling filter 219 increases the number of video frames (or video frame rate) by a factor of T and increases the dimensions of each video frame νₜ by a factor of M. Post-processing network 222 may generate post-processed output video 122 by processing the upscaled video data generated by interpolation and upscaling filter 219.

In aspects, the trained weights corresponding to the neural networks at pre-processing device 102 (e.g., scaling prediction device 206 and/or pre-processing network 208) are not transmitted to video decoder 106. Alternatively, post-processing device 108 may receive a subset of the trained weights (e.g., weights corresponding to one or more layers) corresponding to the neural networks at pre-processing device 102 (e.g., scaling prediction device 206 and/or pre-processing network 208). Alternatively, post-processing device 108 may receive the entire set of trained weights corresponding to the neural networks at pre-processing device 102 that are updated for each video data 112. Post-processing network 222 generates post-processed output video 122 by processing the temporally and spatially upscaled video data generated by interpolation and upscaling filter 219.

Various embodiments may be implemented, for example, using one or more well-known computer systems, such as computer system 800 shown in FIG. 8. One or more computer systems 800 may be used, for example, to implement any of the embodiments discussed herein—such as pre-processing device 102, video encoder 104, video decoder 106, and post-processing device 108 of FIGS. 1, 2A, 2B, 3A, 3B, 4, and 5—as well as combinations and sub-combinations thereof. For example, one or more computer systems can be used to execute the operations of method 500 of FIG. 5, the operations of method 600 of FIG. 6, and the operations of method 700 of FIG. 7.

Computer system 800 may include one or more processor devices (also called central processing units, or CPUs), such as a processor device 804. Processor device 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processor device 804 may be a graphics processing unit (GPU). In an embodiment, a GPU may be a processor device that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory device 808, such as a random access memory (RAM) device. Main memory device 808 may include one or more levels of cache. Main memory device 808 may have stored therein control logic (e.g., computer software) and/or data.

Computer system 800 may also include one or more secondary storage devices or memory device 810. Secondary memory device 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage device 818. Removable storage device 818 may include a computer usable or readable storage device having stored thereon computer software (control logic) and/or data. Removable storage device 818 may be a floppy disk, magnetic tape, compact disk, DVD, optical storage disk, and/any other computer data storage device. Removable storage drive 814 may read from and/or write to removable storage device 818.

Secondary memory device 810 may include other means, devices, components, instrumentalities or other approaches for allowing computer programs and/or other instructions and/or data to be accessed by computer system 800. Such means, devices, components, instrumentalities or other approaches may include, for example, a removable storage device 822 and an interface 820. Examples of the removable storage device 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage device and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In embodiments, a tangible, non-transitory apparatus or article of manufacture including a tangible, non-transitory computer useable or readable medium having control logic (software) stored thereon may also be referred to herein as a computer program product or program storage device. This includes, but is not limited to, computer system 800, main memory device 808, secondary memory device 810, and removable storage devices 818 and 822, as well as tangible articles of manufacture embodying any combination of the foregoing. Such control logic, when executed by one or more data processing devices (such as computer system 800), may cause such data processing devices to operate as described herein.

Additional embodiments can be found in one or more of the following clauses:
1. A system for encoding video data includes a memory device and one or more processor devices coupled to the memory device. The one or more processor devices are configured to determine a temporal scaling factor based on a measure of temporal variability of the video data. The one or more processor devices are further configured to determine a spatial scaling factor based on a measure of spatial variability of the video data. The one or more processors generate temporally and spatially down-scaled video data based on the temporal and spatial scaling factors. The one or more processor devices encode the temporally and spatially down-scaled video data as a neural network having a plurality of weight parameters, and generate a bit stream of encoded video data based on the plurality of weight parameters.
2. The system of clause 1, where to determine the temporal and spatial scaling factors, the one or more processor devices are further configured to input the measures of the temporal and spatial variabilities of the video data to a first neural network (e.g., scaling prediction device 206) comprising a first plurality of convolutional neural network layers to generate the temporal and spatial scaling factors.
3. The system of clauses 1 and 2, where to generate the temporally and spatially down-scaled video data, the one or more processor devices are further configured to input the video data to a second neural network (e.g., pre-processing network 208) comprising a second plurality of convolutional neural network layers to generate multiple high-frequency components. The high-frequency components are added to the video data to generate modified video data. The one or more processor devices then generate, using a space-time scaling filter, the temporally and spatially down-scaled video data by temporally and spatially down-scaling the modified video data based on the temporal and spatial scaling factors.
4. The system of clauses 1 to 3, where the one or more processor devices are configured to train the first neural network, the second neural network, and a post-processing neural network of a decoder to reduce a difference measure between the inputted video data to the first and second neural networks and a corresponding decoded video data.
5. The system of clauses 1 to 3, wherein the one or more processor devices are configured to not transmit trained weights corresponding to the first and the second plurality of convolutional neural network layers to a video decoder.
6. The system of clauses 1 to 5, where the one or more processor devices are further configured to transmit the temporal and spatial scaling factors and the bit stream of the encoded video data to a video decoder.
7. The system of clauses 1 to 6, where the temporal scaling factor has a value between zero and one and is proportional to the measure of temporal variability.
8. The system of clauses 1 to 7, where the spatial scaling factor has a value between zero and one and is proportional to the measure of spatial variability.
9. The system of clause 1 to 8, where to generate the bit stream of encoded video data, the one or more processor devices are further configured to prune the plurality of weight parameters to generate a plurality of pruned weight parameters, quantize the plurality of pruned weight parameters to generate a plurality of quantized weight parameters, and entropy encode the plurality of quantized weight parameters to generate the bit stream of encoded video data.
10. The system of clauses 1 to 9, where the one or more processor devices are configured to train the neural network to reduce a loss function value comprising an entropy penalization term.
11. The system of clauses 1 to 10, where the one or more processor devices are configured to train the neural network to reduce a loss function value comprising an output of a conditional general adversarial network.
12. The system of clause 1 to 11, where the neural network comprises a multi-layer perceptron network and a plurality of convolutional neural network layers.
13. The system of clauses 1 to 12, where the neural network is configured to receive a frame index value, and output a predicted video frame corresponding to the temporally and spatially down-scaled video data and the frame index value.
14. A system for decoding video data includes a memory device and one or more processor devices coupled to the memory device. The one or more processor devices are configured to receive a temporal scaling factor, a spatial scaling factor, and a plurality of weight parameters of down-scaled video data. The temporal scaling factor and the spatial scaling factor are based on a temporal variability and a spatial variability of an original version of the down-scaled video data, and the down-scaled video data is based on a neural network encoding of the original version of the down-scaled video data based on the temporal and spatial scaling factors. The one or more processor devices are configured to generate predicted video data corresponding to the down-scaled video data using the plurality of weight parameters. The one or more processor devices are configured to generate, using a post-processing neural network, decoded video data based on the predicted video data, the temporal scaling factor, and the spatial scaling factor.
15. The system of clause 14, where, to generate the decoded video data, the one or more processor devices are further configured to generate, using a space-time scaling filter, up-scaled video data by temporally and spatially up-scaling the predicted video data based on the temporal and spatial scaling factors, and input the up-scaled video data to the post-processing neural network to generate the decoded video data.
16. The system of clauses 14 and 15, where the one or more processor devices are configured to train a pre-processing neural network of the transmitting device and the post-processing neural network to reduce a difference measure between the decoded video data and a corresponding video data input to the pre-processing neural network.
17. The system of clauses 14 to 16, where the temporal scaling factor has a value between zero and one and is proportional to the temporal variability.
18. The system of clauses 14 to 17, where the spatial scaling factor has a value between zero and one and is proportional to the spatial variability.
19. A method includes determining a temporal scaling factor based on a measure of temporal variability of the video data and determining a spatial scaling factor based on a measure of spatial variability of the video data. The method further includes generating temporally and spatially down-scaled video data based on the temporal and spatial scaling factors, encoding the temporally and spatially down-scaled video data as a neural network having a plurality of weight parameters, and generating a bit stream of encoded video data based on the plurality of weight parameters.
20. The method of clause 19 further includes receiving the temporal scaling factor, the spatial scaling factor, and the plurality of weight parameters of the encoded video data. The method further includes generating predicted video data corresponding to the encoded video data using the plurality of weight parameters, and generating, using a post-processing neural network, decoded video data based on the predicted video data, the temporal scaling factor, and the spatial scaling factor.
21. The method of clauses 19 and 20, where the temporal scaling factor has a value between zero and one and is proportional to the measure of temporal variability, and the spatial scaling factor has a value between zero and one and is proportional to the measure of spatial variability.
22. A system for encoding video data includes a memory device and one or more processor devices coupled to the memory device. The one or more processor devices are configured to determine, using a first neural network of a neural network-based pre-processing device, a measure of temporal variability of the video data and a measure of spatial variability of the video data. The one or processor devices are further configured to determine a temporal scaling factor for the video data based on the measure of temporal variability, and determine a spatial scaling factor for the video data based on the measure of spatial variability. The one or more processor devices are further configured to generate, using a second neural network of the neural network-based pre-processing device, a plurality of high-frequency components and add the plurality of high-frequency components to the video data to generate modified video data. The one or more processor devices are further configured to generate, using a space-time scaling filter, a down-scaled video data by temporally and spatially down-scaling the modified video data based on the temporal and spatial scaling factors. The one or more processor devices are further configured encode the down-scaled video data as a third neural network having a plurality of weight parameters, and generate a bit stream of encoded video data from the plurality of weight parameters.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all embodiments as contemplated by the inventor(s), and thus, are not intended to limit this disclosure or the appended claims in any way.

While this disclosure describes embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described embodiments, but should be defined only in accordance with the following claims and their equivalents.

What is claimed is:

1. A system for encoding video data, comprising:
a memory device; and
one or more processor devices coupled to the memory device and configured to:
determine a temporal scaling factor based on a measure of temporal variability of the video data;
determine a spatial scaling factor based on a measure of spatial variability of the video data;
generate temporally and spatially down-scaled video data based on the temporal and spatial scaling factors;
encode the temporally and spatially down-scaled video data as a neural network having a plurality of weight parameters; and
generate a bit stream of encoded video data based on the plurality of weight parameters.

2. The system of claim 1, wherein to determine the temporal and spatial scaling factors, the one or more processor devices are further configured to input the measures of the temporal and spatial variabilities of the video data to a first neural network comprising a first plurality of convolutional neural network layers to generate the temporal and spatial scaling factors.

3. The system of claim 2, wherein to generate the temporally and spatially down-scaled video data, the one or more processor devices are further configured to:
input the video data to a second neural network comprising a second plurality of convolutional neural network layers to generate a plurality of high-frequency components;
add the plurality of high-frequency components to the video data to generate modified video data; and
generate, using a space-time scaling filter, the temporally and spatially down-scaled video data by temporally and spatially down-scaling the modified video data based on the temporal and spatial scaling factors.

4. The system of claim 3, wherein the one or more processor devices are configured to train the first neural network, the second neural network, and a post-processing neural network of a decoder to reduce a difference measure between the inputted video data to the first and second neural networks and a corresponding decoded video data.

5. The system of claim 3, wherein the one or more processor devices are configured to not transmit trained weights corresponding to the first and the second plurality of convolutional neural network layers to a video decoder.

6. The system of claim 1, wherein the one or more processor devices are further configured to transmit the temporal and spatial scaling factors and the bit stream of the encoded video data to a video decoder.

7. The system of claim 1, wherein the temporal scaling factor has a value between zero and one and is proportional to the measure of temporal variability.

8. The system of claim 1, wherein the spatial scaling factor has a value between zero and one and is proportional to the measure of spatial variability.

9. The system of claim 1, wherein to generate the bit stream of encoded video data, the one or more processor devices are further configured to:
prune the plurality of weight parameters to generate a plurality of pruned weight parameters;
quantize the plurality of pruned weight parameters to generate a plurality of quantized weight parameters; and
entropy encode the plurality of quantized weight parameters to generate the bit stream of encoded video data.

10. The system of claim 1, wherein the one or more processor devices are configured to train the neural network to reduce a loss function value comprising an entropy penalization term.

11. The system of claim 1, wherein the one or more processor devices are configured to train the neural network to reduce a loss function value comprising an output of a conditional general adversarial network.

12. The system of claim 1, wherein the neural network comprises a multi-layer perceptron network and a plurality of convolutional neural network layers.

13. The system of claim 1, wherein the neural network is configured to:
receive a frame index value; and
output a predicted video frame corresponding to the temporally and spatially down-scaled video data and the frame index value.

14. A system for decoding video data, comprising:
a memory device; and
one or more processor devices coupled to the memory device and configured to:
receive a temporal scaling factor, a spatial scaling factor, and a plurality of weight parameters of down-scaled video data,
wherein the temporal scaling factor and the spatial scaling factor are based on a temporal variability and a spatial variability of an original version of the down-scaled video data, and
wherein the down-scaled video data is based on a neural network encoding of the original version of the down-scaled video data based on the temporal and spatial scaling factors;
generate predicted video data corresponding to the down-scaled video data using the plurality of weight parameters; and
generate, using a post-processing neural network, decoded video data based on the predicted video data, the temporal scaling factor, and the spatial scaling factor.

15. The system of claim 14, wherein to generate the decoded video data, the one or more processor devices are further configured to:
generate, using a space-time scaling filter, up-scaled video data by temporally and spatially up-scaling the predicted video data based on the temporal and spatial scaling factors; and
input the up-scaled video data to the post-processing neural network to generate the decoded video data.

16. The system of claim 14, wherein the one or more processor devices are configured to:
train a pre-processing neural network of the transmitting device and the post-processing neural network to reduce a difference measure between the decoded video data and a corresponding video data input to the pre-processing neural network.

17. The system of claim 14, wherein the temporal scaling factor has a value between zero and one and is proportional to the temporal variability.

18. The system of claim 14, wherein the spatial scaling factor has a value between zero and one and is proportional to the spatial variability.

19. A method, comprising:
determining a temporal scaling factor based on a measure of temporal variability of the video data;
determining a spatial scaling factor based on a measure of spatial variability of the video data;
generating temporally and spatially down-scaled video data based on the temporal and spatial scaling factors;
encoding the temporally and spatially down-scaled video data as a neural network having a plurality of weight parameters; and
generating a bit stream of encoded video data based on the plurality of weight parameters.

20. The method of claim 19, further comprising:
receiving the temporal scaling factor, the spatial scaling factor, and the plurality of weight parameters of the encoded video data;
generating predicted video data corresponding to the encoded video data using the plurality of weight parameters; and
generating, using a post-processing neural network, decoded video data based on the predicted video data, the temporal scaling factor, and the spatial scaling factor.
